(19) United States
(12) Patent Application Publication
(10) Pub. No.: US 2026/0317931 A1
(43) Pub. Date: Oct. 15, 2026

(54) USE OF CO2-RICH GAS AS A SWEEPING GAS IN A CHEMICAL PLANT

(71) Applicant: Topsoe A/S, Kgs. Lyngby (DK)

(72) Inventor: Steffen Spangsberg CHRISTENSEN, Køge (DK)

(73) Assignee: Topsoe A/S, Kgs. Lyngby (DK)

(21) Appl. No.: 19/117,241

(22) PCT Filed: Dec. 14, 2023
(86) PCT No.: PCT/EP2023/085796

§ 371 Date: Mar. 31, 2025

(30) Foreign Application Priority Data
Dec. 21, 2022 (EP) 22215499.9

(51) Int. Cl. C25B 15/08; B01D 53/047; B01D 53/26; B01J 8/04; C01B 3/48; C01B 3/56; C25B 1/04; C25B 1/23; C25B 9/70

(52) U.S. Cl. CPC C25B 15/081; B01D 53/047; B01D 53/26; B01J 8/0492; C01B 3/48; C01B 3/56; C25B 1/04; C25B 1/23; C25B 9/70; C25B 15/085; B01D 2256/16; B01D 2257/504; B01D 2257/80; C01B 2203/0244; C01B 2203/0283; C01B 2203/042; C01B 2203/0475

(57) ABSTRACT

A plant, e.g. a syngas plant or hydrogen plant, or a combined syngas and hydrogen plant is provided. The plant comprises a reforming section, a CO₂-removal section and a first electrolysis unit. A first portion of a first CO₂-rich stream outputted from the CO₂-removal section is arranged to be supplied to the anode of the first electrolysis unit as a sweeping gas for oxygen product gas. Certain streams, downstream the first electrolysis unit are arranged to be fed to the reforming section as at least a portion of an oxygen-rich feed. Various processes are also provided for the production of hydrogen and/or syngas in the plant.

### TECHNICAL FIELD

A plant, e.g. a syngas plant or hydrogen plant, or a combined syngas and hydrogen plant is provided. The plant comprises a reforming section, a CO₂-removal section and a first electrolysis unit. A first portion of a first CO₂-rich stream outputted from the CO₂-removal section is arranged to be supplied to the anode of the first electrolysis unit as a sweeping gas for oxygen product gas. Certain streams, downstream the first electrolysis unit are arranged to be fed to the reforming section as at least a portion of an oxygen-rich feed. Various processes are also provided for the production of hydrogen and/or syngas in the plant.

### BACKGROUND

There is increasing interest in the use of electrolysis in industrial chemical plants and processes, to produce gas streams such as oxygen or hydrogen, especially in view of environmental concerns, and the increasing opportunities for using electricity from renewable sources.

An autothermal reformer (ATR) is used to provide a synthesis gas (syngas) stream from a hydrocarbon-rich stream. An ATR typically comprises a burner, a combustion chamber, and a catalyst bed contained within a refractory lined pressure shell. In an ATR, partial combustion of hydrocarbons by sub-stoichiometric amounts of oxygen is followed by steam reforming. ATRs therefore require a co-feed of oxygen for combustion in a burner. This oxygen stream is typically provided by an air separation unit (ASU). Such ASUs are expensive

Oxygen streams from industrial-scale electrolysis processes, such as those which take place in a solid oxide electrolyzer cells (SOEC), is often considered as a waste product, and is simply vented to the atmosphere. If oxygen streams from such industrial-scale electrolysis processes are to be effectively used, a so-called “sweeping gas” or “sweep gas” is typically employed. The sweeping gas is passed into the anode-side of the electrolyser, where it mixes with the oxygen produced at the anode. The resulting combined gas stream containing oxygen is then outputted from the electrolyser. Use of a sweeping gas provides a combined gas stream at a pressure higher than that of the oxygen stream produced in the electrolyser, and can be used e.g. to adjust the chemical and physical composition of the oxygen stream, for a particular use.

Atmospheric air has typically been used as sweeping gas, and has the advantage of being readily-available. However, the use of atmospheric air as sweeping gas can lead to a build-up of inert nitrogen, if recycled to other parts of a chemical plant (e.g. an ATR).

U.S. Pat. No. 8,496,908 describes a steam methane reforming process for producing a hydrogen product while capturing CO₂ from the process.

WO2021/156457 describes a method for supplying oxygen-enriched gas to an oxygen-consuming process. In contrast, the present invention requires CO₂ as a reagent in the oxygen-rich feed to the reforming section—not simply a by-product. CO₂ is thus a carbon feedstock in the reforming reaction, to make best use of carbon. Excess CO₂ is removed downstream the reforming section and recycled.

There remains a need for an energy-effective source of oxygen for an ATR in a chemical plant. There is also a need to make good use of waste streams in chemical plants. These, and other objects, are addressed by the present technology.

### SUMMARY

A plant and process have been developed which reduce energy consumption and the cost of producing an O₂-rich stream to an ATR. The plant may be a hydrogen plant, a syngas plant, or a combined hydrogen and syngas plant.

So, in a first aspect the present invention relates to a plant, said plant comprising
a combined feed of steam and hydrocarbons;
a reforming section comprising an autothermal reformer, said reforming section being arranged to receive said combined feed and an oxygen-rich feed and provide a first syngas stream;
a CO₂-removal section, arranged to receive first syngas stream and provide a first hydrogen-rich stream and a first CO₂-rich stream;
a first electrolysis unit comprising an anode and a cathode;
a first electrolysis feed to said first electrolysis unit;
wherein said first electrolysis unit is arranged to electrolyse the first electrolysis feed into at least an oxygen product gas and a cathode product gas stream;
and wherein
at least a first portion of said first CO₂-rich stream from the CO₂-removal section is arranged to be supplied to the anode of the first electrolysis unit as a sweeping gas for said oxygen product gas, so as to output a first combined gas stream comprising carbon dioxide and oxygen from said electrolysis unit;
optionally, a first water-removal section and a CO₂ separation unit, wherein the first water-removal section is arranged to receive at least a portion of said first combined gas stream from said first electrolysis unit and provide at least a first water-rich stream and a second combined gas stream; and wherein said CO₂ separation unit is arranged to receive at least a portion of the second combined gas stream from the first water-removal section and provide at least a second CO₂-rich stream and an oxygen-rich stream;
and wherein one or more streams selected from:
   at least a portion of the combined gas stream from the first electrolysis unit,
   a second portion of said second combined gas stream, if present, and
   at least a portion of said oxygen-rich stream, if present, is/are arranged to be fed to the reforming section as at least a portion of said oxygen-rich feed.

A process for the production of hydrogen and/or syngas in the plant of the invention is also provided, said process comprising the steps of:
providing a plant according to the invention;
feeding the combined feed of steam and hydrocarbons, and the oxygen-rich feed, to the reforming section comprising an autothermal reformer, so as to provide a first syngas stream;
feeding the first syngas stream to the CO₂-removal section, so as to provide a first hydrogen-rich stream and a first CO₂-rich stream;
feeding the first electrolysis feed to the first electrolysis unit and electrolysing it into at least an oxygen product gas and a cathode product gas stream;
supplying at least a first portion of said first CO₂-rich stream from the CO₂-removal section to the anode of the first electrolysis unit as a sweeping gas for said oxygen product gas, and outputting a first combined gas stream comprising carbon dioxide and oxygen from said electrolysis unit;
optionally, where the plant comprises a first water-removal section and a CO₂ separation unit,
   feeding at least a portion of said first combined gas stream from the first electrolysis unit to the first water-removal section so as to provide at least a first water-rich stream and a second combined gas stream; and
   feeding at least a portion of the second combined gas stream from the first water-removal section to the CO₂ separation unit and providing at least a second CO₂-rich stream and an oxygen-rich stream;
said process comprising the additional step of feeding one or more streams selected from:
   at least a portion of the combined gas stream from the first electrolysis unit,
   a second portion of said second combined gas stream, if present, and
   at least a portion of said oxygen-rich stream, if present,
to the reforming section as at least a portion of said oxygen-rich feed.

Further details of the technology are to be found in the accompanying figures, claims and description text.

The present invention is based on the recognition that it is possible to use CO₂ recycled from a CO₂-removal section placed downstream of the autothermal reformer as sweeping gas in the anode side of an electrolyser in order to sweep oxygen formed therein. The present invention is further based on the recognition that when using CO₂ as a sweeping gas, purification of the combined oxygen and sweeping gas stream before use in the autothermal reformer may be avoided, since CO₂ unlike e.g. nitrogen of atmospheric air is not an undesired component in the autothermal reformer. The present invention is further based on the recognition that the said recycling of CO₂ optimizes the carbon mass balance of the plant of the invention in that all carbon fed to the plant may be utilized to form a syngas product.

Finally, as compared to using an oxygen feed for the autothermal reformer formed in an Air Separation Unit (ASU), oxygen originating from the anode side of an electrolyser does not comprise any contaminants, such as argon, nitrogen and helium, which needs to be separated off before use in the autothermal reformer.

### LEGENDS

The following schematic figures are provided, in which:

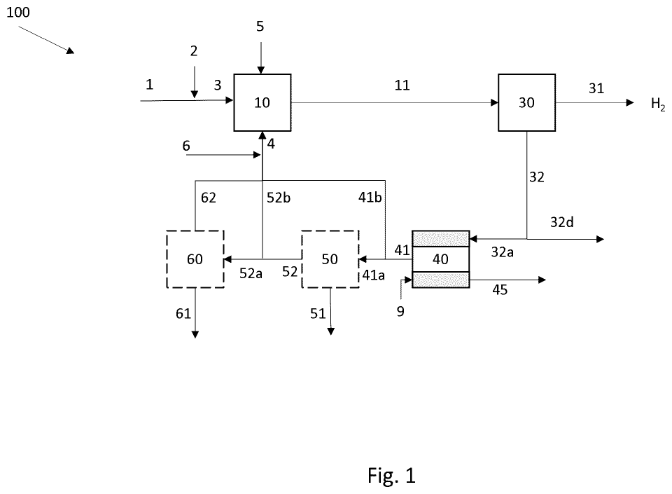

FIG. 1 illustrates a general layout of the plant.

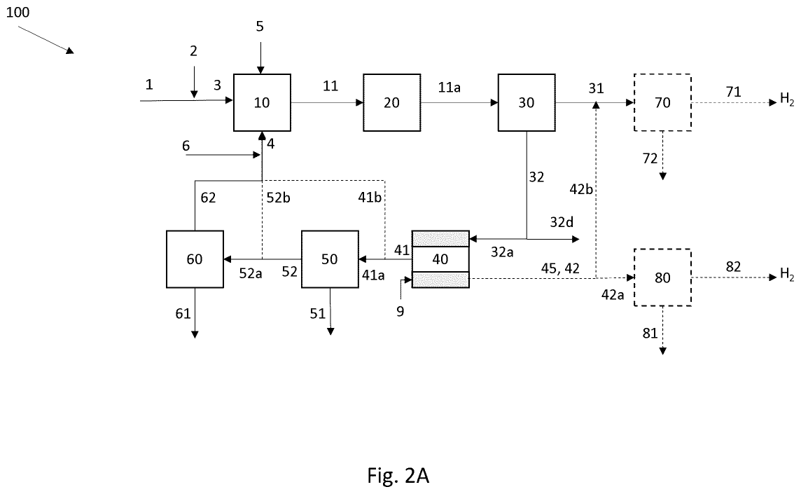

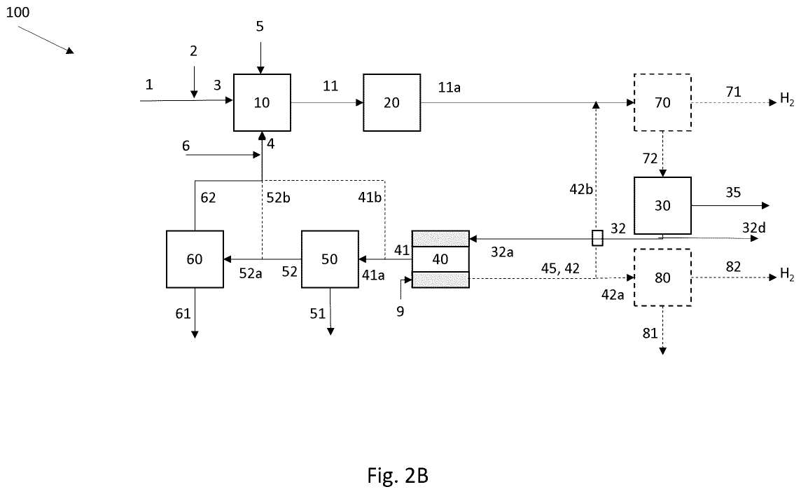

FIGS. 2A and 2B illustrate variations of a hydrogen plant

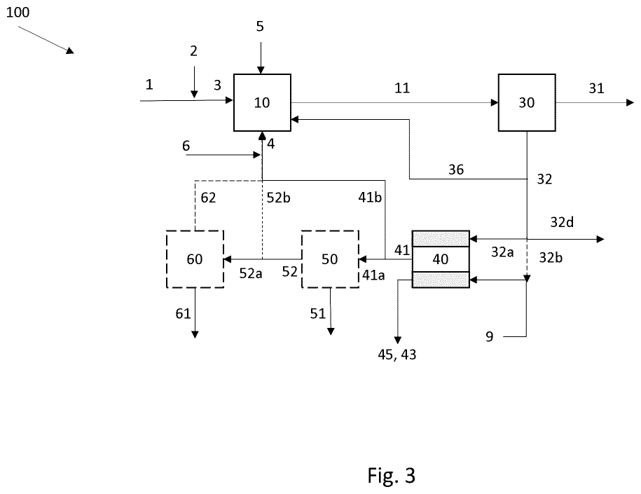

FIG. 3 illustrates a syngas plant.

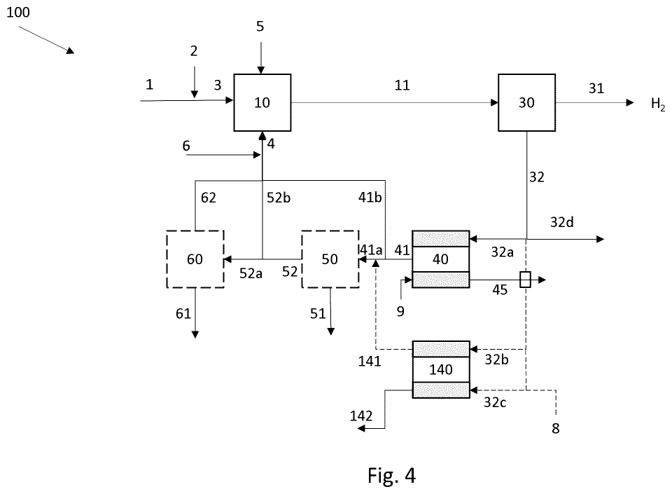

FIG. 4 illustrates a general layout of the plant, based on the layout of FIG. 1.

### DETAILED DISCLOSURE

Unless otherwise specified, any given percentages for gas content are % by volume.

The term “synthesis gas” (abbreviated to “syngas”) is meant to denote a gas comprising hydrogen, carbon monoxide, carbon dioxide, steam and small amounts of other gasses, such as argon, nitrogen, methane, etc.

The term “sweeping gas” means a gas supplied to the electrolysis unit for use as a carrier for carrying O2 out from the electrolysis unit, and the chemical components of the sweeping gas are not subjected to any chemical reaction or conversion during passage through the electrolysis unit.

A plant is provided, which comprises, in general terms:
a combined feed of steam and hydrocarbons;
a reforming section comprising an autothermal reformer;
a CO₂-removal section;
a first electrolysis unit comprising an anode and a cathode;
a first electrolysis feed to the first electrolysis unit;
optionally, a first water-removal section and a CO₂ separation unit.

### Combined Feed

A combined feed of steam and hydrocarbons is provided. The combined feed is typically provided by mixing a steam feed and a hydrocarbon feed. The hydrocarbon feed may suitably be a feed of natural gas, LPG, naphtha and various hydrocarbon containing off-gasses from other plants/processes. The hydrocarbon feed is suitably methane-rich, e.g. it comprises more than 90% methane, such as more than 95% methane, and preferably more than 98% methane.

The combined feed is fed to the reforming section-specifically to the ATR—where it is converted to a first syngas stream.

### Reforming Section

The reforming section comprises an autothermal reformer (ATR). The reforming section is arranged to receive the combined feed and an oxygen-rich feed and provide a first syngas stream.

An ATR typically comprises a burner, a combustion chamber, and a catalyst bed contained within a refractory lined pressure shell. In an ATR, partial combustion of hydrocarbons by sub-stoichiometric amounts of oxygen is followed by steam reforming—i.e., the reverse of reaction (1) and (2)—of the partially combusted hydrocarbons in a fixed bed of steam reforming catalyst.

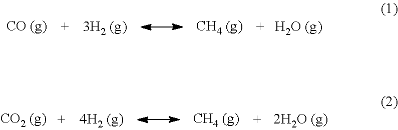

Typically, the gas is at or close to equilibrium at the outlet of the reactor with respect to steam reforming and water gas shift reactions. More details of ATR and a full description can be found in the art such as “Studies in Surface Science and Catalysis, Vol. 152,” Synthesis gas production for FT synthesis “; Chapter 4, p. 258-352, 2004”

The first syngas stream suitably has a composition as follows:
H₂ 65-75 dry %,
CO 15-30 dry %,
CO₂ 4-8 dry %,
CH₄ 1.5-6 dry %

The oxygen-rich feed provides the required oxygen to the ATR burner. The oxygen-rich feed suitably comprises more than 50% oxygen, such as more than 60% oxygen, preferably more than 90% oxygen and preferably more than 99% oxygen.

The oxygen-rich feed suitably comprises up to 50% CO₂, such as up to 30% CO₂, preferably up to 20% CO₂, and preferably up to 10% CO₂.

The oxygen-rich feed to the reforming section is generated by one or more other components of the plant, as set out below. Other components of this oxygen-rich feed may include H₂O and CO₂.

The reforming section may further comprise a prereformer, arranged upstream the autothermal reformer, and arranged to prereform the combined feed to form a pre-reformed combined feed, and arranged to feed the prereformed combined feed to the autothermal reformer. In the prereformer, the higher hydrocarbons contained in the natural gas feed are converted into methane, thus reducing the formation of coke in the primary reformer.

### CO₂-Removal Section

The CO₂-removal section is arranged to receive the first syngas stream and provide a first hydrogen-rich stream and a first CO₂-rich stream.

Removal of CO₂ provides a hydrogen-rich stream with as a low CO₂-content, such as below 2% 1%, preferably below 0.5%, more preferably below 0.1% on dry gas basis.

The CO₂-rich stream typically comprises at least 99% (e.g. 99.8) dry % CO₂ and below 1 dry % (e.g. 0.2 dry %) H₂. The main impurity in the CO₂-rich stream is H₂. Other impurities include Ar, CH₄, CO, N₂ which may be present at (insignificant) ppm levels.

If the CO₂-removal section is located upstream a PSA unit, it is suitably a solvent-based unit such as an amine wash unit. If the CO₂-removal section is located downstream a PSA unit it is suitably a cryogenic unit.

### First Electrolysis Unit

A first electrolysis feed is provided to the first electrolysis unit. The first electrolysis unit is arranged to electrolyse the first electrolysis feed into at least an oxygen product gas and a cathode product gas stream. The first electrolysis unit comprises an anode and a cathode. Preferably, the first electrolysis unit is one or more solid oxide electrolyzer cells (SOECs). SOEC design and construction is known e.g. from WO2013/164172, the contents of which are incorporated by reference. Alternatively, the first electrolysis unit of the plant of the invention may be an alkaline eletrolyzer or a proton exchange membrane (PEM) electrolyser.

The first electrolysis feed may be a water-rich feed or a CO₂-rich feed, depending on the desired outcome. In one aspect, the first electrolysis feed is a water-rich feed and the first electrolysis unit is arranged to electrolyse the first electrolysis feed into oxygen as anode product gas and hydrogen as cathode product gas. In another aspect, the first electrolysis feed is a CO₂-rich feed and the first electrolysis unit is arranged to electrolyse the first electrolysis feed into oxygen as anode product gas and carbon monoxide as cathode product gas. In a further aspect, the first electrolysis feed may be a CO₂-rich feed, and may additionally comprise water.

At least a first portion of the first CO₂-rich stream from the CO₂-removal section is arranged to be supplied to the anode of the first electrolysis unit as a sweeping gas (also known as “flushing gas”) for the oxygen product gas, so as to output a first combined gas stream comprising carbon dioxide and oxygen from said electrolysis unit. Use of CO₂ as sweeping gas in this manner reduces the build-up of inerts such as nitrogen, which would otherwise be present if atmospheric air were used as a sweeping gas.

When using CO₂ as the sweeping gas, the swept stream leaving the electrolysis plant will only contain O₂ and CO₂, typically 50% of each. The sweeping gas can be used directly in the ATR burner or can be mixed with additional O₂ e.g., from an air separating unit (ASU). Using this sweeping gas stream will reduce energy consumption and the cost of ASU. The CO₂ may be recycled in the process and can be captured in a downstream CO₂ removal unit. Alternatively, the CO₂ in the sweeping gas exiting SOEC can be removed, such as condensed out, to obtain a clean O₂ stream for the ATR burner and a clean CO₂ stream, which can be recycled back to the SOEC.

A portion of the combined gas stream from the first electrolysis unit, may be arranged to be fed (i.e. directly fed) to the reforming section as at least a portion of said oxygen-rich feed.

Alternatively, or additionally, at least a portion of this combined gas stream may be further purified, before being fed to the reforming section. In particular, the plant may further comprise a first water-removal section and a CO₂ separation unit. The first water-removal section and a CO₂ separation unit are arranged in series, to purify the combined gas stream. The first water-removal section-if present—is arranged to receive at least a portion of the first combined gas stream from the first electrolysis unit and provide at least a first water-rich stream and a second combined gas stream. The CO₂ separation unit-if present—is arranged to receive at least a portion of the second combined gas stream from the first water-removal section and provide at least a second CO₂-rich stream and an oxygen-rich stream.

As noted above, one or more oxygen-containing streams may be used as the oxygen-rich feed to the reforming section. In the present invention, one or more streams selected from:
at least a portion of the combined gas stream from the first electrolysis unit,
a second portion of said second combined gas stream, if present, and
at least a portion of said oxygen-rich stream, if present,
   is/are arranged to be fed to the reforming section as at least a portion of said oxygen-rich feed.

It is preferred that the plant comprises first water-removal section and CO₂ separation unit as specified, and that at least a portion of the oxygen-rich stream from the CO₂ separation unit, is arranged to be fed to the reforming section as at least a portion of said oxygen-rich feed.

The oxygen content of the oxygen-rich feed to the reforming section depends on the origin of the stream from which it is comprised. If the oxygen-rich feed is supplied from the first electrolysis unit (i.e. it is at least a portion of the combined gas stream from the first electrolysis unit) it comprises O₂, CO₂ and water.

If the oxygen-rich feed is supplied from the first water-removal section (i.e. it is at least a portion of the second combined gas stream from the first water-removal section) it may have a higher oxygen content than that outputted from the first electrolysis unit, the remainder of this stream being primarily CO₂.

If the oxygen-rich feed is supplied from the first water-removal section (i.e. it is at least a portion of the oxygen-rich stream from the CO₂ separation unit) it may have an oxygen content of more than 99%.

In one aspect, at least a portion of the first water-rich stream from the first water-removal section is provided as a portion of the first water-rich feed to the first electrolysis unit. Additional oxygen feed may be supplied as at least a portion of the oxygen-rich feed, e.g. during startup.

During e.g., startup, a portion of the oxygen-rich feed may be provided from a different source, e.g., an ASU.

### Hydrogen Plant

The plant of the invention may be a hydrogen plant, and may therefore further comprise a shift section arranged to receive the first syngas stream from the reforming section, and provide a shifted first syngas stream to the CO₂-removal section. Hydrogen production is thus promoted.

In the hydrogen plant, the first electrolysis feed is a water-rich feed, and the first electrolysis unit is thus arranged to electrolyse the first electrolysis feed into oxygen product gas. The cathode product gas stream, being a hydrogen-rich product stream.

The hydrogen plant comprises a first water-removal section and a CO₂ separation unit, arranged as above. At least a portion of the oxygen-rich stream (from the CO₂ separation unit) is arranged to be fed to the reforming section as at least a portion of said oxygen-rich feed.

The first hydrogen-rich stream from the CO₂-removal section may be provided from the hydrogen plant as a raw hydrogen stream. If required, the hydrogen plant may further comprise a pressure-swing absorption (PSA) unit, said PSA unit being arranged to receive the first hydrogen-rich stream from the CO₂-removal section, and provide a purified hydrogen stream and a PSA off-gas stream. The PSA off-gas (mostly comprising H₂ and CH₄) may be used as feed or fuel elsewhere in the plant, or exported from the plant.

In an alternative arrangement, shown in FIG. 2B, the PSA unit is located between shift section and the CO₂-removal section. The PSA unit is arranged to receive the shifted first syngas stream from the shift section and provide a purified hydrogen stream and a PSA off-gas stream, and feed the PSA off-gas stream to the CO₂-removal section. The CO₂ removal section removes CO₂ from the PSA off-gas stream to a first CO₂-rich stream (which is fed to the electrolysis section, as above) and a CO₂ removal section off-gas stream. A condensate stream is also provided, comprising mostly water. The off-gas stream from the CO₂ removal section may be used as feed for the reformer or as fuel for a fired heater, as required.

In one aspect, the hydrogen plant comprises a second water-removal section arranged to receive at least a first portion of the hydrogen-rich product stream from the first electrolysis unit and provide at least a second water-rich stream and a second purified hydrogen stream. The second purified hydrogen stream can be outputted from the hydrogen plant, as a supplement to the first hydrogen-rich stream.

If further purification of the second purified hydrogen stream is required, it may be passed to the PSA unit. In other words, at least a second portion of the hydrogen-rich product stream from the first electrolysis unit may be arranged to be fed to the inlet of the PSA unit, typically in admixture with the first hydrogen-rich stream from the CO₂-removal section.

### Syngas Plant

The plant may be a syngas plant. In this embodiment, the first electrolysis feed is a water-rich feed, and the first electrolysis unit is arranged to electrolyse the first electrolysis feed into a cathode product gas stream being a syngas product stream.

In this embodiment, the oxygen-rich feed to the reforming section need not have a high oxygen content. Therefore, at least a portion of the combined gas stream from the first electrolysis unit is arranged to be fed to the reforming section as at least a portion of said oxygen-rich feed.

In this embodiment, the first CO₂-rich stream from the CO₂-removal section may have additional uses; namely, as feed to the first electrolysis unit. In other words, the first electrolysis feed may comprise a second portion of the first CO₂-rich stream from the CO₂-removal section.

The CO₂ used as feed to the electrolysis unit may also be derived from the CO₂ separation unit. In this case, the first electrolysis feed comprises at least a portion of the second CO₂-rich stream from the CO₂ separation unit.

The syngas plant may further comprise a second water-removal section. The second water-removal section may be arranged to receive at least a portion of the first hydrogen-rich stream and provide at least a second water-rich stream and a second combined gas stream.

### Second Electrolysis Unit

The plant (the hydrogen plant, or the syngas plant) may further comprise a second electrolysis unit. The second electrolysis unit allows flexibility in terms of the input streams to the plant. The second electrolysis unit may comprise one or more solid oxide electrolyzer cells (SOECs). Alternatively, the second electrolysis unit of the plant of the invention may be an alkaline eletrolyzer or a proton exchange membrane (PEM) electrolyser.

In this embodiment, a second portion of the first CO₂-rich stream from the CO₂-removal section may be arranged to be supplied as electrolysis feed to the second electrolysis unit. The second electrolysis unit is arranged to electrolyse the second portion of the first CO₂-rich stream into an oxygen product gas and a CO-containing stream.

A third portion of the first CO₂-rich stream from the CO₂-removal section is arranged to be supplied to the anode of the second electrolysis unit as a sweeping gas for said oxygen product gas, so as to output a first combined gas stream comprising carbon dioxide and oxygen from said second electrolysis unit.

In this embodiment, a water feed may be arranged to be mixed with the second portion of the of the first CO₂-rich stream, upstream the second electrolysis unit. The co-electrolysis of water with the CO₂-rich stream will produce H₂. So, the electrolysis product (CO-containing stream) will be a mixture of CO and H₂ which is a syngas that can be used for methanol production or other chemical production.

The second electrolysis unit allows H₂ production in the main line and the second electrolysis unit making syngas by CO₂ electrolysis. Likewise, a syngas production can take place in the main line and the second electrolysis unit could provide H₂ by water electrolysis.

### Additional Units

The plant may comprise a second water-removal section arranged to receive at least a first portion of the hydrogen-rich product stream from said first electrolysis unit and provide at least a second water-rich stream and a second purified hydrogen stream. This second purified hydrogen stream may be exported from the plant as hydrogen product, optionally together with the first hydrogen stream.

In one aspect, at least a portion of the second water-rich stream outputted from the second water-removal section is provided as a portion of the first water-rich feed to the first electrolysis unit.

The plant may further comprise a second water-removal section, the second water-removal section, being arranged to receive at least a portion of said first hydrogen-rich stream and provide at least a second water-rich stream and a second combined gas stream.

### Processes

The invention also provides a number of processes in the plants described above.

A process is provided for the production of hydrogen and/or syngas in the plant described herein. This process comprises the steps of:
providing a plant as described herein;
feeding the combined feed of steam and hydrocarbons, and the oxygen-rich feed, to the reforming section comprising an autothermal reformer, so as to provide a first syngas stream;
feeding the first syngas stream to the CO₂-removal section, so as to provide a first hydrogen-rich stream and a first CO₂-rich stream;
feeding the first electrolysis feed to the first electrolysis unit and electrolysing it into at least an oxygen product gas and a cathode product gas stream;
supplying at least a first portion of said first CO₂-rich stream from the CO₂-removal section to the anode of the first electrolysis unit as a sweeping gas for said oxygen product gas, and outputting a first combined gas stream comprising carbon dioxide and oxygen from said electrolysis unit;
optionally, where the plant comprises a first water-removal section and a CO₂ separation unit,
   feeding at least a portion of said first combined gas stream from the first electrolysis unit to the first water-removal section so as to provide at least a first water-rich stream and a second combined gas stream; and
   feeding at least a portion of the second combined gas stream from the first water-removal section to the CO₂ separation unit and providing at least a second CO₂-rich stream and an oxygen-rich stream;
said process comprising the additional step of feeding one or more streams selected from:
   at least a portion of the combined gas stream from the first electrolysis unit,
   a second portion of said second combined gas stream, if present, and
   at least a portion of said oxygen-rich stream, if present, to the reforming section as at least a portion of said oxygen-rich feed.

A process for the production of hydrogen is also provided, in a hydrogen plant described herein. This process comprises the steps of:
providing a hydrogen plant according to the invention;
feeding the combined feed of steam and hydrocarbons, and the oxygen-rich feed, to the reforming section comprising an autothermal reformer, so as to provide a first syngas stream;
feeding the first syngas stream from the reforming section to the shift section, so as to provide a shifted first syngas stream to the CO₂-removal section,
feeding the shifted first syngas stream to the CO₂-removal section, so as to provide a first hydrogen-rich stream and a first CO₂-rich stream;
feeding the first electrolysis feed, being a water-rich feed, to the first electrolysis unit and electrolysing it into at least an oxygen product gas and a cathode product gas stream being a hydrogen-rich product stream;
supplying at least a first portion of said first CO₂-rich stream from the CO₂-removal section to the anode of the first electrolysis unit as a sweeping gas for said oxygen product gas, and outputting a first combined gas stream comprising carbon dioxide and oxygen from said electrolysis unit;
feeding at least a portion of said first combined gas stream from the first electrolysis unit to the first water-removal section so as to provide at least a first water-rich stream and a second combined gas stream; and
feeding at least a portion of the second combined gas stream from the first water-removal section to the CO₂ separation unit and providing at least a second CO₂-rich stream and an oxygen-rich stream;
said process comprising the additional step of feeding at least a portion of said oxygen-rich stream to the reforming section as at least a portion of said oxygen-rich feed.

A process for the production of syngas is also provided, in a syngas plant described herein. This process comprises the steps of:
providing a syngas plant as described herein;
feeding the combined feed of steam and hydrocarbons, and the oxygen-rich feed, to the reforming section comprising an autothermal reformer, so as to provide a first syngas stream;
feeding the first syngas stream from the reforming section to the shift section, so as to provide a shifted first syngas stream to the CO₂-removal section,
feeding the shifted first syngas stream to the CO₂-removal section, so as to provide a first hydrogen-rich stream and a first CO₂-rich stream;
feeding the first electrolysis feed, being a water-rich feed, to the first electrolysis unit and electrolysing it into at least an oxygen product gas and a cathode product gas stream being a syngas product stream;
supplying at least a first portion of said first CO₂-rich stream from the CO₂-removal section to the anode of the first electrolysis unit as a sweeping gas for said oxygen product gas, and outputting a first combined gas stream comprising carbon dioxide and oxygen from said electrolysis unit;
feeding at least a portion of said first combined gas stream from the first electrolysis unit to the reforming section as at least a portion of said oxygen-rich feed.

The process according to this embodiment may further comprising a step of feeding a second portion of said first CO₂-rich stream from the CO₂-removal section to the first electrolysis unit as at least a portion of the first electrolysis feed.

All details of the plants according to the invention are applicable to the processes, mutatis mutandis.

### Specific Embodiments

FIG. 1 illustrates a general layout of the plant (100). Combined feed (3) of steam (2) and hydrocarbons (1) is fed to the reforming section (10) together with an oxygen-rich feed (4) so as to provide a first syngas stream (11). The first syngas stream (11) is fed to the CO₂-removal section (30), and a first hydrogen-rich stream (31) and a first CO₂-rich stream (32) are provided.

First electrolysis feed (9), e.g. water or CO₂, or a mixture thereof, is provided to the first electrolysis unit (40), where it is electrolysed into at least an oxygen product gas and a cathode product gas stream (45).

A first portion (32a) of the first CO₂-rich stream (32) from the CO₂-removal section (30) is supplied to the anode of the first electrolysis unit (40) as a sweeping gas for the oxygen product gas. Another portion (32d) of the first CO₂-rich stream (32) from the CO₂-removal section (30) may be exported, as it may not be necessary that all of this stream is recycled through the electrolysis unit (40). A first combined gas stream (41) comprising carbon dioxide and oxygen from said electrolysis unit (40) is outputted from the first electrolysis unit (40).

FIG. 1 also shows, a first water-removal section (50) and a CO₂ separation unit (60), both of which are optional. The first water-removal section (50) is arranged to receive at least a portion (41a) of the first combined gas stream (41) from the first electrolysis unit (40) and provide at least a first water-rich stream (51) and a second combined gas stream (52). The CO₂ separation unit (60) is arranged to receive at least a portion (52a) of the second combined gas stream (52) from the first water-removal section (50) and provide at least a second CO₂-rich stream (61) and an oxygen-rich stream (62).

As also shown in FIG. 1, one or more streams is/are arranged to be fed to the reforming section (10) as at least a portion of said oxygen-rich feed (4). Such feeds are selected from:
at least a portion (41b) of the combined gas stream (41) from the first electrolysis unit (40),
a second portion (52b) of said second combined gas stream (52), if present, and
at least a portion of said oxygen-rich stream (62), if present.

Additional oxygen feed (6) may be supplied as at least a portion of the oxygen-rich feed, e.g. during startup. A steam feed (5) may be supplied to the reforming section (10).

FIGS. 2A and 2B illustrate variations of a hydrogen plant, based on the layout of FIG. 1. These figures comprise the same elements as FIG. 1, with the addition of: shift section (20), PSA unit (70), which generates purified hydrogen stream (71) and a PSA off-gas stream (72), and second water-removal section (80), which provides a second water-rich stream (81) and a second purified hydrogen stream (82). In FIG. 2A, the PSA unit is located downstream the CO₂-removal section (30), while in FIG. 2B, the PSA unit is located upstream the CO₂-removal section (30). Purified hydrogen stream (71) is exported from the plant. In this embodiment, the first electrolysis feed (9) is a water-rich feed.

FIG. 3 illustrates a syngas plant, based on the layout of FIG. 1. FIG. 3 comprises the same elements as FIG. 1. Also in this embodiment, the first electrolysis feed (9) is a water-rich feed, which may comprise a portion of the first CO₂-rich stream (32) from the CO₂-removal section (30). The cathode product gas stream (45) from the first electrolysis unit (40) is a syngas product stream (43), which is exported from the plant. A CO₂ recycle stream (36) from CO₂-removal section (30) to the reforming section (10). It may not be possible to recycle all CO₂-rich stream (32) through first electrolysis unit (40).

FIG. 4 illustrates a general layout of the plant, based on the layout of FIG. 1. This layout includes a second electrolysis unit (140). A second portion (32b) of the first CO₂-rich stream (32) from the CO₂-removal section (30) is arranged to be supplied as electrolysis feed to the second electrolysis unit (140). The second electrolysis unit (140) electrolyses the second portion (32b) of the first CO₂-rich stream (32) into an oxygen product gas and a CO-containing stream (142). Also, a third portion (32c) of the first CO₂-rich stream (32) from the CO₂-removal section (30) is supplied to the anode of the second electrolysis unit (140) as a sweeping gas for said oxygen product gas, so as to output a first combined gas stream (141) comprising carbon dioxide and oxygen from said second electrolysis unit (140).

Although the present invention is described with reference to a number of aspects and embodiments, the skilled person may combine such aspects and embodiments, within the scope of the appended claims. All documents referenced herein are incorporated by reference.

1. A plant, said plant comprising
a combined feed of steam and hydrocarbons;
a reforming section comprising an autothermal reformer, said reforming section being arranged to receive said combined feed and an oxygen-rich feed and provide a first syngas stream;
a CO2-removal section, arranged to receive first syngas stream and provide a first hydrogen-rich stream and a first CO2-rich stream;
a first electrolysis unit comprising an anode and a cathode;
a first electrolysis feed to said first electrolysis unit;
wherein said first electrolysis unit is arranged to electrolyse the first electrolysis feed into at least an oxygen product gas and a cathode product gas stream; and
wherein at least a first portion of said first CO2-rich stream from the CO2-removal section is arranged to be supplied to the anode of the first electrolysis unit as a sweeping gas for said oxygen product gas, so as to output a first combined gas stream comprising carbon dioxide and oxygen from said electrolysis unit;
optionally, a first water-removal section and a CO2 separation unit, wherein the first water-removal section is arranged to receive at least a portion of said first combined gas stream from said first electrolysis unit and provide at least a first water-rich stream and a second combined gas stream, and wherein said CO2 separation unit is arranged to receive at least a portion of the second combined gas stream from the first water-removal section and provide at least a second CO2-rich stream and an oxygen-rich stream; and
wherein one or more streams selected from:
at least a portion of the combined gas stream from the first electrolysis unit,
a second portion of said second combined gas stream, if present, and
at least a portion of said oxygen-rich stream, if present,
is/are arranged to be fed to the reforming section as at least a portion of said oxygen-rich feed.

2. The plant according to claim 1, wherein said reforming section further comprises a prereformer arranged upstream the autothermal reformer, and arranged to prereform the combined feed to form a pre-reformed combined feed, and arranged to feed the prereformed combined feed to the autothermal reformer.

3. The plant according to claim 1, wherein the first electrolysis feed is a water-rich feed and wherein said first electrolysis unit is arranged to electrolyse the first electrolysis feed into oxygen as anode product gas and hydrogen as cathode product gas.

4. The plant according to claim 1, wherein the first electrolysis feed is a CO2-rich feed and wherein said first electrolysis unit is arranged to electrolyse the first electrolysis feed into oxygen as anode product gas and carbon monoxide as cathode product gas.

5. The plant according to claim 1, being a hydrogen plant, and further comprising:
a shift section arranged to receive the first syngas stream from the reforming section, and provide a shifted first syngas stream to the CO2-removal section,
wherein the first electrolysis feed is a water-rich feed and wherein said first electrolysis unit is arranged to electrolyse the first electrolysis feed into oxygen product gas and wherein the cathode product gas stream is a hydrogen-rich product stream, and
wherein said hydrogen plant comprises a first water-removal section and a CO2 separation unit, wherein the first water-removal section is arranged to receive at least a portion of said first combined gas stream from said first electrolysis unit and provide at least a first water-rich stream and a second combined gas stream; and wherein said CO2 separation unit is arranged to receive at least a portion of the second combined gas stream from the first water-removal section and provide at least a second CO2-rich stream and an oxygen-rich stream; and
wherein at least a portion of said oxygen-rich stream is arranged to be fed to the reforming section as at least a portion of said oxygen-rich feed.

6. The plant according to claim 5, further comprising a pressure-swing absorption unit, said PSA unit being arranged to receive the first hydrogen-rich stream from the CO2-removal section, and provide a purified hydrogen stream and a PSA off-gas stream.

7. The plant according to claim 5, further comprising a pressure-swing absorption unit, said PSA unit being arranged to receive the shifted first syngas stream from the shift section and provide a purified hydrogen stream and a PSA off-gas stream, and feed said PSA off-gas stream to said CO2-removal section.

8. The plant according to claim 5, wherein
at least a portion of the combined gas stream from the first electrolysis unit, and/or
a second portion of said second combined gas stream,
is/are also arranged to be fed to the reforming section as at least a portion of said oxygen-rich feed.

9. The plant according to claim 5, wherein the plant comprises a second water-removal section arranged to receive at least a first portion of the hydrogen-rich product stream from said first electrolysis unit and provide at least a second water-rich stream and a second purified hydrogen stream.

10. The plant according to claim 9, wherein a second portion of the hydrogen-rich product stream from the first electrolysis unit is arranged to be fed to the inlet of the PSA unit.

11. The plant according to claim 1, being a syngas plant,
wherein the first electrolysis feed is a water-rich feed
wherein said first electrolysis unit is arranged to electrolyse the first electrolysis feed into a cathode product gas stream being a syngas product stream, and
wherein at least a portion of the combined gas stream from the first electrolysis unit is arranged to be fed to the reforming section as at least a portion of said oxygen-rich feed.

12. The plant according to claim 11, wherein the first electrolysis feed comprises a second portion of said first CO2-rich stream from the CO2-removal section.

13. The plant according to claim 11, wherein the first electrolysis feed comprises at least a portion of the second CO2-rich stream from the CO2 separation unit.

14. The plant according to claim 11, wherein the first electrolysis feed, being a CO2-rich feed, additionally comprises water.

15. The plant according to claim 11, said plant further comprising:
a second electrolysis unit;
wherein a second portion of the first CO2-rich stream from the CO2-removal section is arranged to be supplied as electrolysis feed to the second electrolysis unit,
wherein said second electrolysis unit is arranged to electrolyse the second portion of the first CO2-rich stream into an oxygen product gas and a CO-containing stream;
wherein a third portion of the first CO2-rich stream from the CO2-removal section is arranged to be supplied to the anode of the second electrolysis unit as a sweeping gas for said oxygen product gas, so as to output a first combined gas stream comprising carbon dioxide and oxygen from said second electrolysis unit.

16. The plant according to claim 15, wherein a water feed is arranged to be mixed with the second portion of the of the first CO2-rich stream, upstream the second electrolysis unit.

17. The plant according to claim 1, wherein the first and second electrolysis units comprises one or more solid oxide electrolyzer cells.

18. A process for the production of hydrogen and/or syngas in the plant according to claim 1, said process comprising the steps of:
providing the plant;
feeding the combined feed of steam and hydrocarbons, and the oxygen-rich feed, to the reforming section comprising an autothermal reformer, so as to provide a first syngas stream;
feeding the first syngas stream to the CO2-removal section, so as to provide a first hydrogen-rich stream and a first CO2-rich stream;
feeding the first electrolysis feed to the first electrolysis unit and electrolysing it into at least an oxygen product gas and a cathode product gas stream;
supplying at least a first portion of said first CO2-rich stream from the CO2-removal section to the anode of the first electrolysis unit as a sweeping gas for said oxygen product gas, and outputting a first combined gas stream comprising carbon dioxide and oxygen from said electrolysis unit;
optionally, where the plant comprises a first water-removal section and a CO2 separation unit,
feeding at least a portion of said first combined gas stream from the first electrolysis unit to the first water-removal section so as to provide at least a first water-rich stream and a second combined gas stream; and
feeding at least a portion of the second combined gas stream from the first water-removal section to the CO2 separation unit and providing at least a second CO2-rich stream and an oxygen-rich stream;
said process comprising the additional step of feeding one or more streams selected from:
at least a portion of the combined gas stream from the first electrolysis unit,
a second portion of said second combined gas stream, if present, and at least a portion of said oxygen-rich stream, if present,
to the reforming section as at least a portion of said oxygen-rich feed.

19. A process for the production of hydrogen, in the hydrogen plant according to claim 5, said process comprising the steps of:
providing the hydrogen plant;
feeding the combined feed of steam and hydrocarbons, and the oxygen-rich feed, to the reforming section comprising an autothermal reformer, so as to provide a first syngas stream;
feeding the first syngas stream from the reforming section to the shift section, so as to provide a shifted first syngas stream to the CO2-removal section,
feeding the shifted first syngas stream to the CO2-removal section, so as to provide a first hydrogen-rich stream and a first CO2-rich stream;
feeding the first electrolysis feed, being a water-rich feed, to the first electrolysis unit and electrolysing it into at least an oxygen product gas and a cathode product gas stream being a hydrogen-rich product stream;
supplying at least a first portion of said first CO2-rich stream from the CO2-removal section to the anode of the first electrolysis unit as a sweeping gas for said oxygen product gas, and outputting a first combined gas stream comprising carbon dioxide and oxygen from said electrolysis unit;
feeding at least a portion of said first combined gas stream from the first electrolysis unit to the first water-removal section so as to provide at least a first water-rich stream and a second combined gas stream; and
feeding at least a portion of the second combined gas stream from the first water-removal section to the CO2 separation unit and providing at least a second CO2-rich stream and an oxygen-rich stream;
said process comprising the additional step of feeding at least a portion of said oxygen-rich stream to the reforming section as at least a portion of said oxygen-rich feed.

20. A process for the production of syngas, in a syngas plant according to claim 11 said process comprising the steps of:
providing the syngas plant;
feeding the combined feed of steam and hydrocarbons, and the oxygen-rich feed, to the reforming section comprising an autothermal reformer, so as to provide a first syngas stream;
feeding the first syngas stream from the reforming section to the shift section, so as to provide a shifted first syngas stream to the CO2-removal section,
feeding the shifted first syngas stream to the CO2-removal section, so as to provide a first hydrogen-rich stream and a first CO2-rich stream;
feeding the first electrolysis feed, being a water-rich feed, to the first electrolysis unit and electrolysing it into at least an oxygen product gas and a cathode product gas stream being a syngas product stream;
supplying at least a first portion of said first CO2-rich stream from the CO2-removal section to the anode of the first electrolysis unit as a sweeping gas for said oxygen product gas, and outputting a first combined gas stream comprising carbon dioxide and oxygen from said electrolysis unit;
feeding at least a portion of said first combined gas stream from the first electrolysis unit to the reforming section as at least a portion of said oxygen-rich feed.

21. The process according to claim 20, further comprising a step of feeding a second portion of said first CO2-rich stream from the CO2-removal section to the first electrolysis unit as at least a portion of the first electrolysis feed.
